(19) United States
(12) Patent Application Publication
(10) Pub. No.: US 2006/0015621 A1
(43) Pub. Date: Jan. 19, 2006

(54) System and method for information handling system task selective wireless networking

(76) Inventor: Liam B. Quinn, Austin, TX (US)

Correspondence Address: HAMILTON & TERRILE, LLP, P.O. BOX 203518, AUSTIN, TX, 78720, US

(21) Appl. No.: 10/890,014

(22) Filed: Jul. 13, 2004

(51) Int. Cl. G06F 15/16

(52) U.S. Cl. 709/227

(57) ABSTRACT

Information handling system networking tasks are allocated between personal and local area wireless networks according to one or more factors, such as information content or network congestion. Network communications through co-located wireless local and personal area network transceivers are managed with a task allocation module so that networking bandwidth is used more effectively. For instance, office applications communicate through a personal area network, such as an Ultrawide band network, to accomplish multimedia tasks, such as video display, VoIP communication and personal network attached storage access, without causing congestion on wider used enterprise networks, such as 802.11(b) local area networks.

### BACKGROUND OF THE INVENTION

1. Field of the Invention

The present invention relates in general to the field of information handling system networking, and more particularly to a system and method for task selective wireless networking.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often interact with each other and a number of different types of peripherals through networks in order to communicate, print or otherwise process information. Typical local area networks interface information handling systems and peripherals with wires, such as Ethernet cables, in peer-to-peer or server-client architectures. Businesses often invest considerable amounts of money in purchasing information handling systems and stringing cables through structures to network the information handling systems. However, home-based information handling systems tend to avoid wired network configurations due to the cost and complexity. For businesses, investments in effective information technology and networking often pay substantial dividends through improved productivity of employees who are better able to quickly access and use relevant information. Recent improvements in information handling system applications and peripherals have made effective networking of even greater importance to businesses. For instances, employees increasingly rely on desktop, notebook and PDA information handling systems to perform various tasks in the office environment ranging from basic tasks, such as telephone service provided by Voice over Internet Protocol (VoIP), to data intensive tasks, such as multimedia tasks that involve communication of relatively large amounts of data like the display of HDTV signals on a LCD monitor. Similarly, a growing number of homes rely on information handling systems to manage busy schedules, complex finances and a wide variety of multimedia applications relating to the storage and display of music and movies.

As businesses have increased their reliance on networking of information handling systems, industry has responded by developing wireless networking conventions for business and home use. Wireless networks communicate information with radio waves thereby reducing the need to connect information handling systems and peripherals with cables. For instance, the IEEE 802.11 standard includes a number of wireless protocols, such as the 802.11a standard operating at a frequency of 5 GHz, the 802.11b standard operating at 2.4 GHz with the Direct Sequence Spread Spectrum and having relatively rapid data transfers to an approximate range of 100 meters, and the 802.11g standard known as Bluetooth operating at 2.4 GHz and having relatively slow data transfers to an approximate range of 10 meters. Businesses that use wireless local area networks (WLANs) typically deploy 802.11b compliant access points throughout a business structure with each in turn typically interfaced to an access point and switch through an Ethernet connection to support network connectivity. In a WLAN, each networked information handling system and peripheral has a wireless card that communicates with the server through the wireless access points. The wireless access points typically negotiate frequency use within a defined spectrum to coordinate simultaneous communication between multiple devices without undue interference or congestion. A difficulty with WLANs is the use of a shared access fairness architecture under the 802.11b standard that results in congestion during heavy network use, such as might arise with multiple users or during multimedia operations, which slows overall network capacity and effectiveness. The Bluetooth standard is typically used in Wireless Personal Area Networks (WPAN), however, due to the Bluetooth standard's relatively low data transfer rate, its application are generally limited to basic peripherals, such as keyboards and mice. In order to improve data transfer rates in WPAN environments, industry has developed an Ultrawide Band standard (UWB) that uses the 3.1 to 10.6 GHz frequency band and a strong protocol stack to provide rapid data transfers in short range peer-to-peer architectures for low noise, low power and cable free device and peripheral connectivity. The UWB standard has a relatively limited range of 10 to 20 meters, however the UWB standard supports high data transfer rates in excess of those available through 802.11b.

### SUMMARY OF THE INVENTION

Therefore a need has arisen for a system and method which selectively allocates tasks between plural wireless networks to improve information handling system networking capacity and efficiency.

In accordance with the present invention, a system and method are provided which substantially reduce the disadvantages and problems associated with previous methods and systems for wireless networking of information handling systems. First and second wireless transceiver are co-located to communicate information between one or more information handling systems and one or more peripherals. The information is allocated between a first local area network associated with the first transceiver and a second personal area network associated with the second transceiver according to one or more desired factors.

More specifically, a multi-mode switch coordinates information communication between one or more information handling systems and one or more peripherals by allocating communication of information between wireless local and personal area networks. A wireless local area network module interfaced with an antenna communicates wireless local area network information such as with 802.11b compliant signals. A wireless personal area network module interfaced with the antenna communicates wireless personal area network information such as through Bluetooth or Ultrawide band compliant signals. Classification of information for communication through the local versus personal area network is according to one or more factors, such as the relative congestion of each network or the content of the information. A task allocation module interfaced with the local and personal area network modules allocates information for communication through each respective network. Bandwidth intensive communication, such as for performing multimedia voice video and data functions, are biased to the personal area network to preserve local area bandwidth for enterprise applications.

The present invention provides a number of important technical advantages. One example of an important technical advantage is that information is allocated for communication between local and personal area networks to more effectively use available bandwidth. Co-location of local and personal area network modules in a common housing or support infrastructure, such as through a common antenna, reduces manufacturing cost and improves coordination of communication of information allocated between the personal and local area networks. The use of a personal area network to communicate information associated with bandwidth-intensive office tasks decreases congestion in enterprise-wide network applications.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling systems and peripherals supported by a multi-mode switch;

FIG. 2 depicts a block diagram of a multi-mode switch configured to support wireless local and personal area networks with a common infrastructure; and

FIG. 3 depicts a block diagram of the multimode switch deployed in business structures to support plural users.

### DETAILED DESCRIPTION

Enterprise and office network communication is supported with allocation between wireless local and personal area networks that selectively communicate information between information handling systems and peripherals based on one or more factors. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

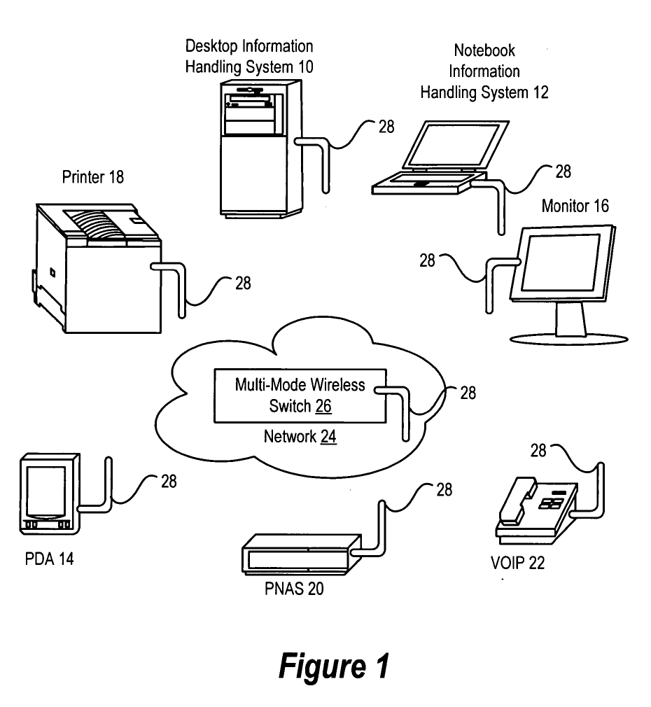

Referring now to FIG. 1, a block diagram depicts information handling systems and peripherals supported by a multi-mode switch that allocates communication of information between wireless local and personal area networks. A desktop information handling 10, notebook information handling system 12 and PDA information handling system 14 include processing components to process and communicate information. Information handling systems 10, 12 and 14 interact with a variety of peripherals to process, communicate, store and display information, such as but not limited to monitor 16, printer 18, personal network attached storage 20 and VoIP device 22. The information handling systems and peripherals communicate through a wireless network 24 supported through a multi-mode wireless switch 26. Each information handling system and peripheral communicates information through an antenna 28 that supports a wireless local area network transceiver and a wireless personal area network transceiver. The wireless local area network supports enterprise-wide communication that allows information handling systems and peripherals to communicate through a local area, such as a factory. Plural wireless personal area networks disposed within the local area network each support personal office space information handling system and peripheral communication, such as within an office cube area.

Multi-mode wireless switch 26 integrates multiple wireless networking modes to support integrated wireless local area and personal area network connectivity. Integrated multi-mode common radio transceiver and antenna structures selectively support communication based on the information's classification as local area or personal area information. For instance, selected tasks performed by information handling systems and peripherals are allocated to an 802.11(b) local area network band, such as communication of information between information handling systems 10, 12 and 14 as well as communication with VoIP device 22 with an enterprise local area network. Other selected tasks performed by information handling systems and peripherals are allocated to an Ultrawide band personal area network, such as communication of information in support of multimedia tasks through personal network attached storage 20 or for display of video with an HDTV or LCD monitor 16. As another example, a Bluetooth personal area network supports communication of basic peripherals, such as a keyboard and mouse. Classification rules are selectable through a user interface that allows permanent classification of certain types of information as personal or local, and that allows variable classification of other types of information based on relative network congestions, such as bandwidth availability. Multi-mode wireless switch 26 integrates the dual transceiver capability within a single housing or, alternatively, in a single structure that inserts into an information handling system, such as a daughter board card.

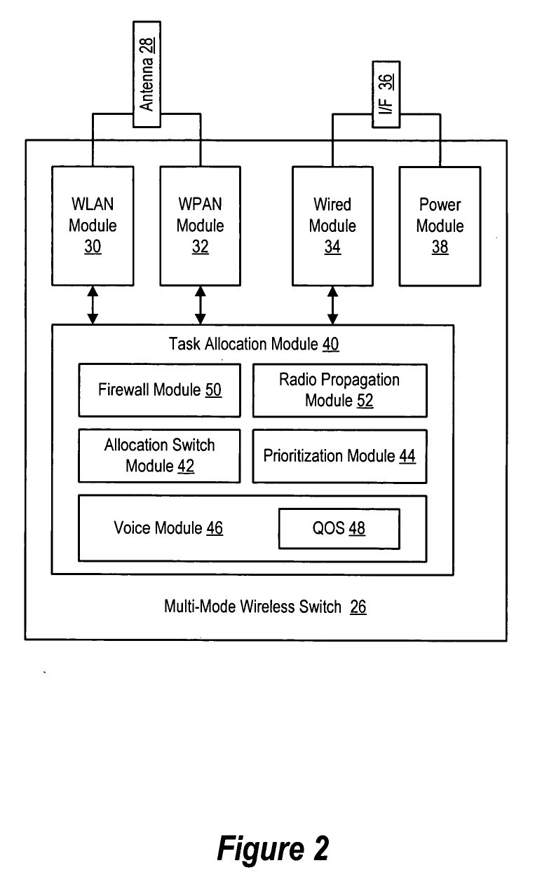

Referring now to FIG. 2 a block diagram depicts a multi-mode switch configured to support wireless local and personal area networks with a common infrastructure disposed in a single housing. A wireless local area network module 30 and wireless personal area network 32 interface with a common antenna 28 to communicate information in each respective network. A wired module 34 communicates with conventional wire-based networks through an Ethernet interface 36. A power module 38 obtains power for operating multi-mode switch 26 with Power over Ethernet (PoE) according to the 802.3af standard.

A task allocation module 40 allocates information for communication through wireless local area network module 30, wireless personal area network module 32 and wired module 34. Classification of information for allocation to a selected network is performed, for instance, with an allocation switch module 42 that assigns networks to communicate information on a task basis. The allocation of tasks is prioritized by a prioritization module 44 based on the traffic type, frequency band and application type, such as information associated with data, video, voice or other specific multimedia applications. For instance, the prioritization module determines prioritization from the source or destination routing information of information or, as another example, from monitoring the amount of information or amount of available bandwidth of the personal and local wireless networks. A voice module 46 supports prioritized communication of VoIP information through WLAN module 30 and wired module 34. For instance, voice module 46 scans periodically for mobile VoIP phones and, upon initiation of a VoIP communication, activates a quality of service engine 48 to tag voice packets for prioritized communication. A firewall module 50 provides for secured access to switch 26 by selected users, and a radio propagation module 44 supports features such as mobility, co-channel interference, link-failover and congestion management.

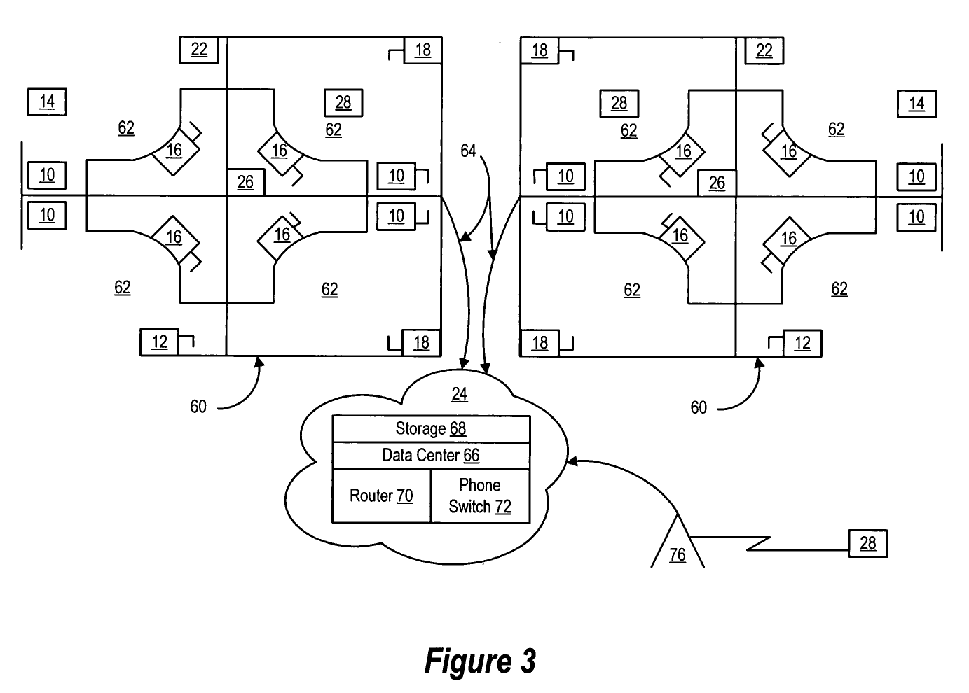

Referring now to FIG. 3, a block diagram depicts an example of deployment of multi-mode wireless switch 26 in a business networking solution. First and second building structures 60 each support office environments having plural office cubicles 62, with each office cubicle 62 supporting a business employee. A multi-mode wireless switch 26 is deployed to support plural cubicles 62, such as the four cubicles depicted in FIG. 3. Depending upon the networking demands of employees, multi-mode wireless switch 26 may support as many as ten or fifteen cubicles with both WLAN and WPAN environments. Multi-mode wireless switch 26 communicates information with a data center 66 through a cable 64 and the business network cloud 24, such as a conventional series of switches and routers. Information handling systems within cubicles 62 access business information technology resources, such as storage 68, external router 70 and phone switch 72, to perform desired business functions, like communication of e-mail, data, voice and video information.

The allocation module within multi-mode wireless switch 26 manages network usage by information handling systems and peripherals within its assigned cubicles 62 by assigning communications between a WLAN and WPAN. For instance, desktop information handling systems 10 that are located in cubicles assigned to a switch 26 communicate with the network cloud through the WLAN while desktop information handling systems outside of the assigned cubicles may be selectively prohibited from use of the switch 26 to limit congestion. In contrast, notebook information handling systems 12 that are portable through the business environment may interact with WLAN hotspots supported by various switches 26 deployed through the business environment. As another example, mobile VoIP phones communicate through WLAN hotspots supported by switches 26 deployed throughout the business environment and with external phones through phone switch 72. Phones that include both wireless VoIP and cellular functionality automatically seek to communicate through the WLAN if available and a cellular tower 76 if no WLAN is available, thus reducing external network communication costs. Desired VoIP quality of service is aided with prioritized allocation of bandwidth of the WLAN to VoIP phones and increased reliance on associated WPANs to communicate other information. Peripherals for each cubicle 62 assigned to a switch 26 primarily communicate through the WPAN defined by the switch 26 to reduce congestion on the WLAN. As tasks having varying network communication demands arise, such as varying data content and transfer rates, multi-mode switch 26 prioritizes transfer of information and allocates tasks between the WLAN and WPAN to optimize network use.

Although the present invention has been described in detail, it should be understood that various changes, substitutions and alterations can be made hereto without departing from the spirit and scope of the invention as defined by the appended claims.

What is claimed is:

1. A system for allocating tasks between wireless networks, the system comprising:
an information handling system operable to process information and having first and second wireless networking interfaces, the first interface operable to support communication through a first wireless network, the second interface operable to support communication through the second wireless network;
plural peripherals, each peripheral operable to interact with the information handling system through at least one of the wireless networks; and
a switch having the first and second wireless interfaces disposed in a housing and operable to selectively allocate communication between the information handling system and peripherals through the first and second wireless networks.

2. The system of claim 1 wherein the first wireless networking interface comprises a wireless local area network and the second wireless networking interface comprises a wireless personal area network.

3. The system of claim 2 wherein the wireless personal area network comprises a Bluetooth network.

4. The system of claim 2 wherein the wireless personal area network comprises an Ultrawide band network.

5. The system of claim 4 wherein the wireless local area network comprises an 802.11(b) network.

6. The system of claim 5 further comprising a task allocation module associated with the switch and operable to allocate communication of information between by the first and second wireless networks according to network congestion.

7. The system of claim 6 wherein the peripherals comprise personal network attached storage having first and second wireless network interfaces.

8. The system of claim 6 wherein the peripherals comprise a VoIP phone having first and second wireless network interfaces.

9. The system of claim 6 wherein the task allocation module is further operable to prioritize a selected of the wireless network interfaces for communication of information.

10. An information handling system networking switch comprising:
an antenna operable to communicate information in a first band associated with a first wireless network and in a second band associated with a second wireless network;
a wireless local area network module interfaced with the antenna and operable to communicate information in the first band;
a wireless personal area network module interfaced with the antenna and operable to communicate information in the second band; and
a task allocation module interfaced with the wireless local area network module and the wireless personal area network, the task allocation module operable to selectively communicate information over the first or second band based on one or more factors.

11. The information handling system networking switch of claim 10 wherein selectively communicating information further comprises determining whether information is of a local area network type of a personal area network type, communicating local area network type information in the first band, and communicating personal area network type information in the second band.

12. The information handling system networking switch of claim 11 wherein information of a personal area network type comprises VoIP information.

13. The information handling system networking switch of claim 11 wherein information of a personal area network type comprises personal network attached data storage data.

14. The information handling system networking switch of claim 11 wherein information of a personal area network type comprises multimedia information for presentation on a video display.

15. The information handling system networking switch of claim 10 wherein the one or more factors comprises congestion on the first and second bands.

16. The information handling system networking switch of claim 10 further comprising:
a wired module interfaced with the task allocation module and operable to communicate information through an Ethernet medium; and
a power module interfaced with the wired module and operable to accept power from the Ethernet medium.

17. A method for communicating information between one or more information handling systems and one or more peripherals, the method comprising:
co-locating first and second wireless network transceivers, the first transceiver communicating information in a first network band, the second transceiver communicating information in a second network band;
classifying network information according to one or more factors as local area network information and personal area network information;
allocating the local area network information to the first wireless transceiver for communication between one or more information handling systems and one or more peripherals; and
allocating the personal area network information to the second wireless transceiver for communication between one or more information handling systems and one or more peripherals.

18. The method of claim 17 wherein classifying network information further comprises:
determining congestion of information associated with the first wireless transceiver; and
biasing classification of information to the second wireless transceiver.

19. The method of claim 17 wherein classifying network information further comprises analyzing information content to associate information with a local or personal networking task.

20. The method of claim 18 wherein personal networking tasks comprise bandwidth-intensive voice, video and data tasks.
